(19) United States
(12) Patent Application Publication
(10) Pub. No.: US 2014/0184596 A1
(43) Pub. Date: Jul. 3, 2014

(54) IMAGE BASED RENDERING

(71) Applicant: MICROSOFT CORPORATION, Redmond, WA (US)

(72) Inventors: Markus Unger, Graz (AT); Konrad Karner, Raaba (AT); Blaise Aguera y Arcas, Seattle, WA (US)

(73) Assignee: Microsoft Corporation, Redmond, WA (US)

(21) Appl. No.: 13/729,424

(22) Filed: Dec. 28, 2012

(51) Int. Cl. G06T 15/00; G06T 15/04; G06T 15/20; G06T 15/80

(52) U.S. Cl. CPC G06T 15/00; G06T 15/80; G06T 15/04; G06T 15/205
USPC 345/423; 345/419; 345/426

(57) ABSTRACT

Among other things, one or more techniques and/or systems are provided for generating geometry using one or more depth images and/or for texturing geometry using one or more texture imagery. That is, geometry (e.g., a three-dimensional representation of a city) may be generated based upon depth information within a depth image. The geometry may be textured by assigning color values to pixels within the geometry based upon texture imagery (e.g., a video and/or an image comprising depth values and/or color values). For example, a 3D point associated with a pixel of the geometry may be projected to a location within texture imagery. If the depth of the pixel corresponds to a depth of the location, then texture information (e.g., a color value) from the texture imagery may be assigned to the pixel. In this way, the textured geometry may be used to generate a rendered image.

### BACKGROUND

Many users consume image data, such as photos, videos, and/or image models from a variety of sources. In an example, a user may view a three-dimensional map provided by a mapping service. In another example, a user may play a video game comprising one or more scenes that are rendered for display on a screen. In another example, a user may manipulate an interactive model of a house provided by a building designer software suite.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for generating geometry and/or texturing the geometry to generate a rendered image are provided herein. In an example of generating geometry, a user may access a mapping service using a mapping application on a client device. The user may submit a request to view a rendered image, such as a three-dimensional rendering of a city. The mapping service may provide a client, such as the mapping application, with one or more depth images (e.g., a first depth image) depicting a scene of the city that is to be represented within the rendered image. Accordingly, a grid corresponding to a space (e.g., a display window of the mapping application) within which the rendered image is to be displayed may be generated. For example, an initial grid may be tessellated to create the grid so that the grid may be substantially proportional to the space. Depth information associated with the depth image (e.g., the first depth image may comprise depth values for respective pixels within the depth image) may be used to displace one or more portions of the grid (e.g., vertices of triangles within the grid may be displaced along a depth direction) to generate a geometry. The geometry may represent, for example, a three-dimensional surface model of the scene (e.g., a digital surface model of the city). In this way, geometry may be generated by a client based upon one or more depth images streamed to the client, for example.

In an example of texturing geometry, a geometry associated with a scene that is to be represented within a rendered image may be received. In an example, the geometry may have been generated by an image based geometry generation technique (e.g., the geometry may have been generated based upon one or more depth images), such as described above. It may be appreciated that in an example, the geometry may have been generated based upon one or more of a variety of techniques, such as a digital surface model technique, a voxel technique, a triangulated irregular network technique, etc. The geometry may comprise one or more pixels corresponding to 3D points within the scene. Respective pixels within the geometry may be textured based upon texture information associated with texture imagery. For example, a first 3D point associated with a first pixel of the geometry may be projected to a first location within first texture imagery (e.g., an image comprising depth values and/or color values) to determine first texture information for the first pixel (e.g., a color value associated with the first location). Responsive to a depth of the first pixel corresponding to a depth of the first location, the first texture information may be assigned to the first pixel. Otherwise, the first pixel may be determined as occluded within the first texture imagery (e.g., a texture image depicting a northern side of a house may not comprise locations corresponding to southern portions of the house). In this way, texture information assigned to respective pixels within the geometry may be (e.g., selectively) applied to generate the rendered image (e.g., a three-dimensional colored image of a building).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of generating geometry from one or more depth images.

FIG. 2 is a flow diagram illustrating an exemplary method of texturing geometry using texture imagery.

FIG. 3 is a component block diagram illustrating an exemplary system for generating geometry from one or more depth images.

FIG. 4A is a component block diagram illustrating an exemplary system for texturing geometry using texture imagery.

FIG. 4B is an illustration of an example of texturing a scene using multiple textures.

FIG. 5 is a component block diagram illustrating an exemplary system for generating a rendered image.

FIG. 6 is an illustration of an exemplary computing device-readable medium wherein processor-executable instructions configured to embody one or more of the provisions set forth herein may be comprised.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

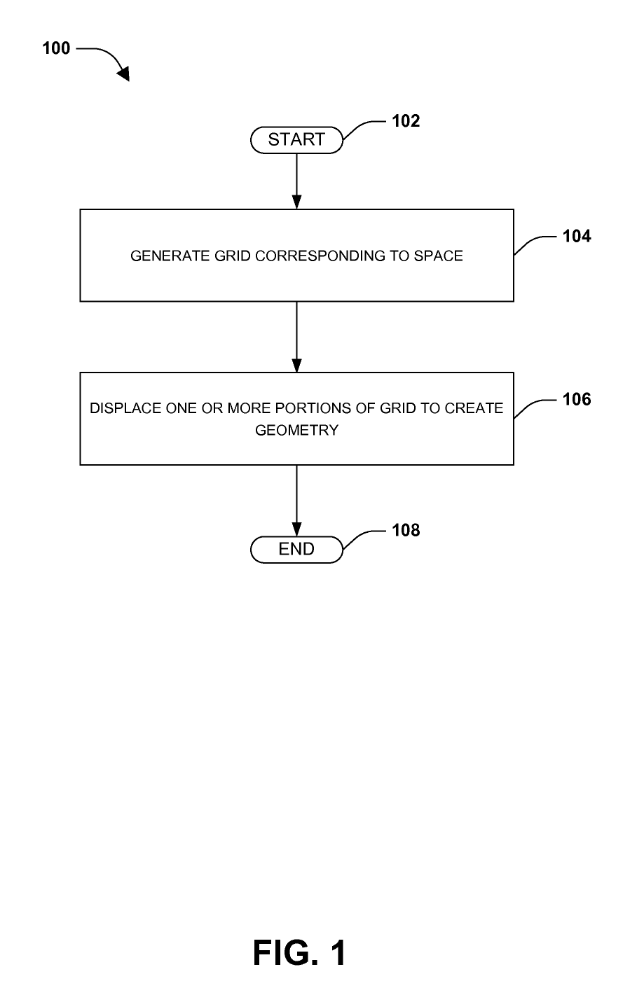

One embodiment of generating geometry from one or more depth images is illustrated by an exemplary method 100 in FIG. 1. At 102, the method starts. In an example, a client application (e.g., a mapping application, a social network, 3D modeling software, a video game, a website, etc.) may be configured to display geometry, such as a rendered image corresponding to a three-dimensional representation of a scene (e.g., a person, an object, an aerial view of a location, a portion of a city, a location, etc.), though a space (e.g., a graphical user interface of the client application). At 104, a grid corresponding to the space within which the rendered image is to be displayed may be generated. For example, an initial grid comprising one or more geometric shapes (e.g., triangles) may be tessellated to create the grid, which may be proportional to the space. In this way, the grid may be modified based upon one or more depth images, such as a depth image streamed to the client application from an image based service (e.g., a mapping web service), so that geometry may be created at a client hosting the client application.

At 106, one or more portions of the grid may be displaced to generate a geometry. For example, vertices of respective geometric shapes of the grid may be displaced along a depth direction based upon depth information (e.g., from a depth image). In this way, the geometry may represent a three-dimensional surface of the scene, such as a digital surface model (DSM), a height map, etc. In an example, the geometry may be blended with second geometry to create blended geometry. That is, the second geometry may be generated based upon a second depth image depicting the scene. The second depth image may depict the scene from a different view point than the first depth image (e.g., the first depth image may depict the scene from a plumb line view direction and the second depth image may depict the scene from an oblique view direction). The geometry may be blended with the second geometry to create a blended geometry. In this way, geometry and/or blended geometry representing the scene, such as the three-dimensional surface of the scene (e.g., a building, a city, etc.), may be generated.

In an example of generating a geometry, one or more depth images captured over time may be used to generate the geometry. For example, a motion capturing device (e.g., a video game motion sensor, a time of flight camera, etc.) may capture a series of depth images over time. The series of depth images may be used to generate the (e.g., blended) geometry. In this way, the geometry may represent a scene (e.g., and variations therein) over time.

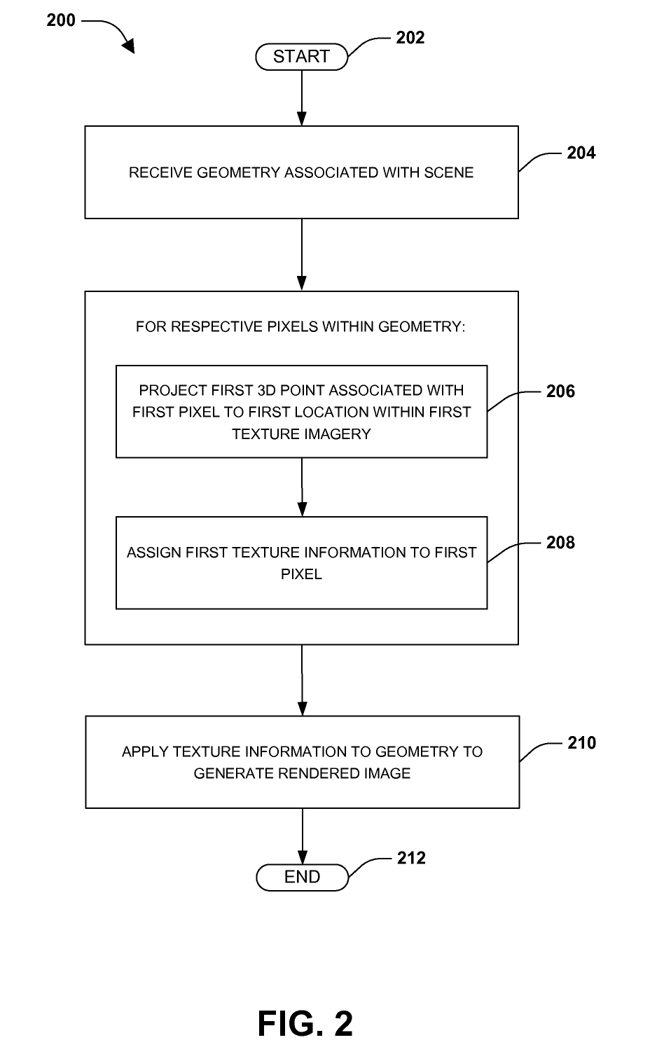

In an example, texture information may be applied to the geometry to generate the rendered image, as further illustrated by exemplary method 200 of FIG. 2. For example, one or more texture imagery or rather one or more images comprising texture information (e.g., an RGB image comprising color values and/or depth values for respective pixel locations within the RGB image; a video; etc.) may be used to assign texture information, such as a color value, to respective pixels within the geometry to generate the rendered image (e.g., a pixel shader of a rendering pipeline may render the geometry, and the rendered geometry may be textured to generate the rendered image). In an example, the one or more texture imagery may be streamed to the client by the image based service, and the rendered image may be generated at the client. In this way, the rendered image (e.g., a three-dimensional colored image depicting the scene) may be generated and/or displayed. At 108, the method ends.

One embodiment of texturing geometry using texture imagery is illustrated by an exemplary method 200 in FIG. 2. At 202, the method starts. At 204, a geometry associated with a scene that is to be represented within a rendered image may be received. In an example, the geometry may correspond to a geometry generated by the exemplary method 100 of FIG. 1 (e.g., a client may have generated the geometry based upon one or more depth images streamed to the client by an image based service, such as a mapping web service). It may be appreciated that in an example, the geometry may have been created by other generation techniques, such as a triangular irregular network technique, a voxel technique, a digital surface model technique, etc. In an example, the geometry may be selectively used based upon a where graph comprising relationship information between geometry and/or texture imagery (e.g., the rendered image may be part of a video that may be constructed based upon relationships between one or more geometries depicting various scenes of the video). The geometry may be textured (e.g., color values may be assigned to pixels within the geometry) based upon one or more texture imagery (e.g., an image comprising depth values and/or color values, which may be streamed to the client by the image based service) to generate the rendered image. In particular, respective pixels within the geometry may be assigned texture information, such as a color value, based upon the one or more texture imagery (e.g., one or more images comprising texture information). In an example of texturing a scene represented by geometry, the scene may be textured from multiple textures, such that a pixel of the scene may be composed (e.g., blended) from multiple texture images.

In an example of assigning texture information to a pixel within the geometry, a first 3D point associated with a first pixel of the geometry may be projected to a first location within a first texture imagery to determine first texture information (e.g., a color value associated with a pixel at the first location within the first texture imagery) for the first pixel, at 206. At 208, responsive to a depth of the first pixel corresponding to a depth of the first location, the first texture information may be assigned to the first pixel of the geometry. However, if the depth of the first pixel does not correspond to the depth of the first location, then the projection of the first pixel may be determined as being occluded (e.g., not visibly depicted) within the first texture imagery (e.g., the first pixel may correspond to a southern facing portion of a house, whereas the first texture imagery may depict a northern facing portion of the house). In an example, the first texture imagery and/or other texture imagery may be selectively used based upon the where graph (e.g., texture imagery corresponding to various scenes of a video may be used to texture one or more geometries associated with the video).

In an example, the first 3D point may be projected within one or more texture imagery, such as a projection of the first 3D point to a second location within second texture imagery used to identify second texture information for the first pixel. The second texture imagery may be selectively used based upon a temporal blending technique (e.g., the second texture imagery may have been created relatively close in time to the first texture imagery) and/or a view direction blending technique (e.g., the second texture imagery may depict the scene from a different viewing direction, which may provide color values for pixels that may be occluded within the first texture imagery). The first texture information and/or the second texture information may be blended together to created blended texture information that may be assigned to the first pixel.

At 210, the texture information assigned to respective pixels within geometry (e.g., the geometry as rendered by a pixel shader of a rendering pipeline) may be applied to generate the rendered image. The rendered image, such as a three-dimensional colored model of the scene, may be rendered by the client (e.g., based upon geometry and/or texture imagery streamed to the client) for display through a space associated with the client (e.g., a graphical user interface of a mapping application hosted by the client). At 212, the method ends.

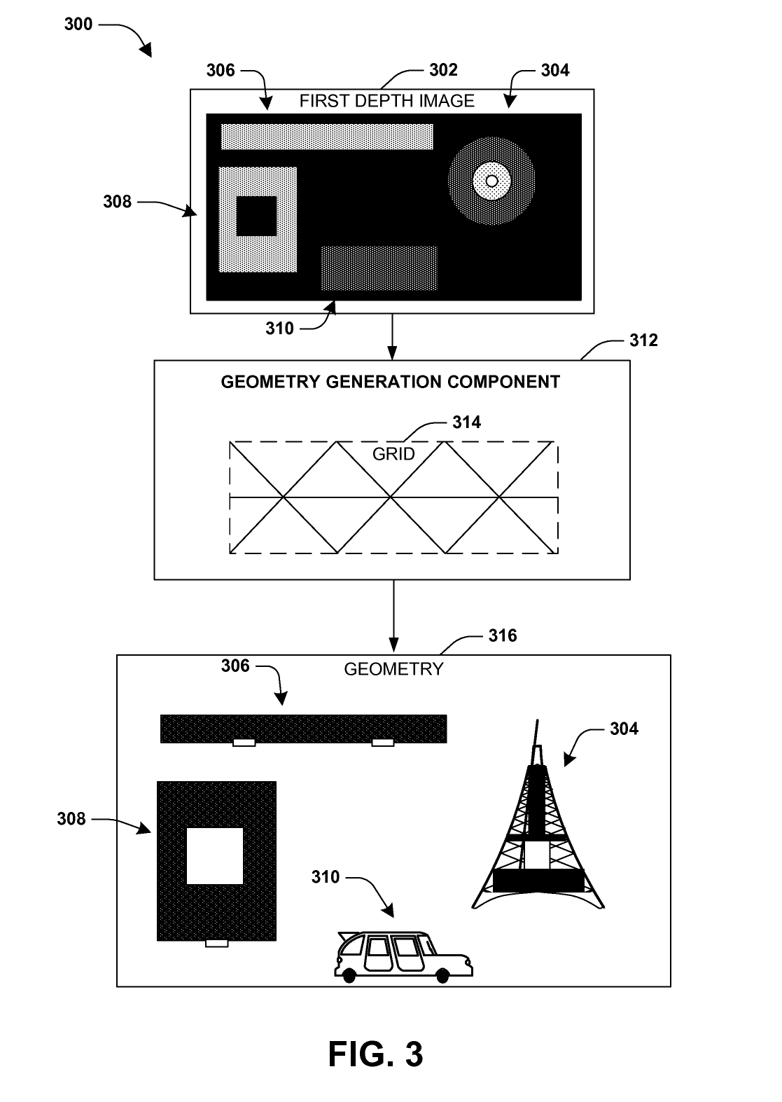

FIG. 3 illustrates an example of a system 300 configured for generating geometry 316 from one or more depth images. The system 300 may comprise a geometry generation component 312. In an example, the geometry generation component 312 may be hosted by a client (e.g., a tablet device hosting a mapping application). The geometry generation component 312 may be configured to receive a first depth image 302. The first depth image 302 may depict a scene (e.g., an aerial view of a city) that is to be represented within a rendered image. For example, the first depth image 302 may depict a building 308, a storefront 306, a car 310, and/or a tower 304. The first depth image 302 may comprise depth values for respective pixels within the first depth image 302 (e.g., relatively darker colors may represent pixels that are relatively farther away from a camera that captured the first depth image 302, while relatively lighter colors may represent pixels that are relatively closer to the camera).

The geometry generation component 312 may be configured to generate a grid 314 corresponding to a space (e.g., a graphical user interface of the mapping application) within which the rendered image is to be displayed. For example, the grid 314 may comprise one or more geometric shapes, such as triangles, that may be sized according to the space. The geometry generation component 312 may be configured to displace one or more portions (e.g., geometric shapes) of the grid 314 to generate the geometry 316 based upon depth information associated with the first depth image 302. For example, the building 308, the storefront 306, the car 310, and/or the tower 304 may be constructed within the geometry 316 based upon corresponding depth values within the depth image 302. In this way, the geometry 316 (e.g., a digital surface model) may comprise a three-dimensional representation of a surface of the scene.

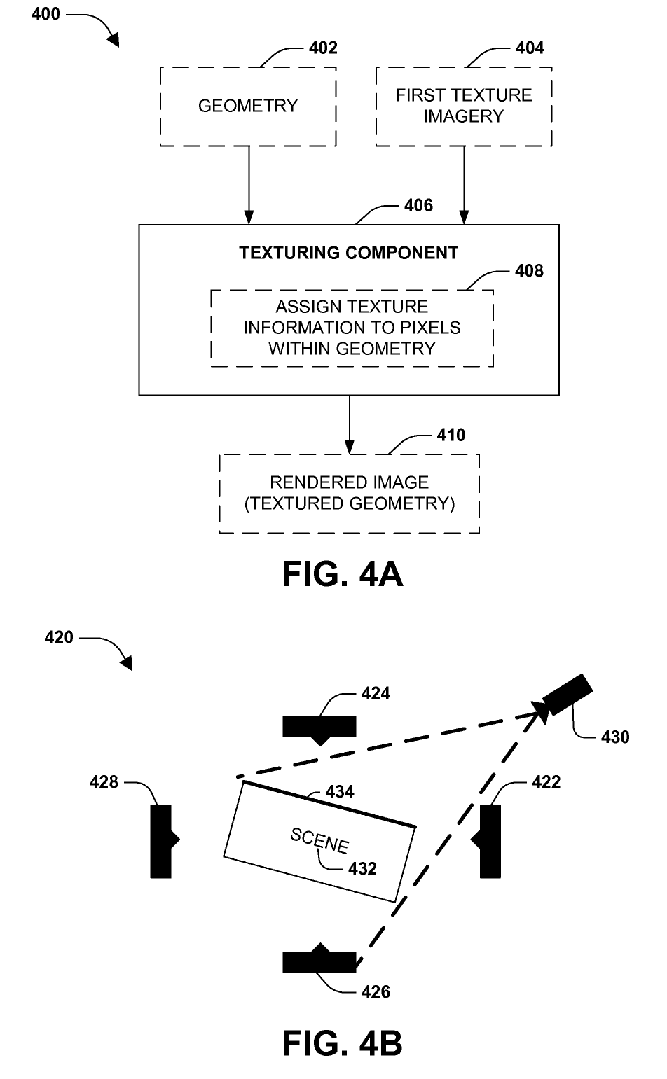

FIG. 4 illustrates an example of a system 400 configured for texturing geometry 402 using texture imagery. The system 400 may comprise a texturing component 406. In an example, the texturing component 406 may be hosted by a client (e.g., a tablet device hosting a mapping application). The texturing component 406 may be configured to receive the geometry 402, such as a three-dimensional depiction of a scene that is to be represented within a rendered image 410. In an example, the texturing component 406 may receive the geometry 402 from a geometry generation component (e.g., a geometry generation component 312 of FIG. 3) configured to generate the geometry 402 based upon one or more depth images. It may be appreciated that the geometry 402 may be received from other sources and/or derived from other techniques, such as a voxel based approach, a digital surface model approach, a triangular irregular network approach, etc.

The texturing component 406 may be configured to receive one or more texture imagery, such as first texture imagery 404 (e.g., an image and/or a video comprising color values and/or depth values for pixels). In an example where the texturing component 406 is hosted by the client, the first texture imagery 404 may be streamed to the client by an image based service (e.g., a website, an image repository, a search engine, a mapping service, etc.). The texturing component 406 may be configured to assign 408 texture information to respective pixels within the geometry 402 to generate the rendered image 410. For example, the texturing component 406 may project a first 3D point associated with a first pixel of the geometry 402 to a location within the first texture imagery 404 to determine first texture information for the first pixel (e.g., a color value associated with the location within the first texture imagery 404). If a depth of the first pixel corresponds to a depth of the first location, then the first texture information may be assigned to the first pixel, otherwise the first pixel may be determined as being occluded (e.g., not visually depicted) within the first texture imagery 404. In this way, the texturing component 406 may generate the rendered image 410 based upon texturing information assigned to respective pixels within the geometry 402.

FIG. 4B illustrates an example 420 of texturing a scene 432 using multiple textures or multiple texture images. One or more texture imagery, such as a first texture imagery 422, a second texture imagery 424, a third texture imagery 426, and/or a fourth texture imagery 428, may depict the scene 432 from various viewpoints that may overlap. In an example, the first texture imagery 422 and the second texture imagery 424 may both depict at least a portion of a first geometry face 434 of the scene 432 that is seen by a camera, at a first position 430. The first texture imagery 422 as well as the second texture imagery 424 may contribute to texturing one or more pixels associated with the first geometry face 434. In this way, first texture contribution from the first texture imagery 422 and second texture contribution from the second texture imagery 424 may be blended to texture the one or more pixels associated with the first geometry face 434. In this way, a pixel of the scene 432 may be textured using multiple textures.

In an example of blending textures to texture a pixel using multiple textures, the blending may be a function of the viewpoint of a camera. For example, if the view direction of the first camera 430 coincides with the view direction of the first texture imagery 422 more than the view direction of the second texture imagery 424, then the first texture imagery 422 will be favored (e.g., a greater percentage of the texture applied to the pixel will be from the first texture imagery 422 than from the second texture imagery 424). Conversely, if the view direction of the first camera 430 coincides with the view direction of the second texture imagery 424 more than the view direction of the first texture imagery 422, then the second texture imagery 424 will contribute more to the texturing of the pixel than the first texture imagery 422. If the view direction of the first camera 430 is substantially in-between the view direction of the first texture imagery 422 and the view direction of the second texture imagery 424, then the first texture imagery 422 and the second texture imagery 424 might contribute equally to the texturing of the pixel, for example.

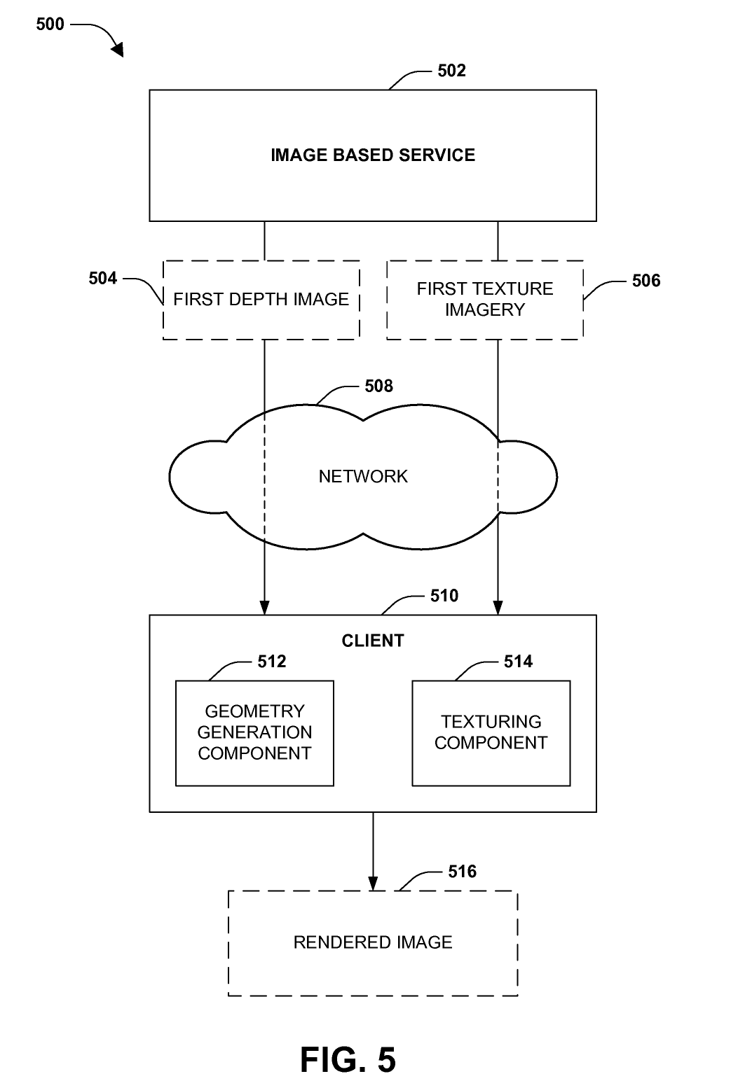

FIG. 5 illustrates an example of a system 500 configured for rendering an image. The system 500 may be associated with a client 510 (e.g., a personal computer, a mobile device, a tablet device, and/or other computing devices). The system 500 may comprise a geometry generation component 512 and/or a texturing component 514. In an example, the client 510 may request, over a network 508, image data (e.g., a three-dimensional representation of a city) from an image based service 502. The image based service 502 may stream one or more depth images, such as a first depth image 504, through the network 508, to the client 510. The geometry generation component 512 may modify a grid using depth information within the one or more depth images to generate geometry (e.g., a surface model of the three-dimensional representation of the city). The image based service 502 may send one or more texture imagery, such as first texture imagery 506, through the network 508, to the client 510. The texturing component 514 may apply texture information from the one or more texture imagery to generate a rendered image 516 (e.g., a three-dimensional textured representation of the city).

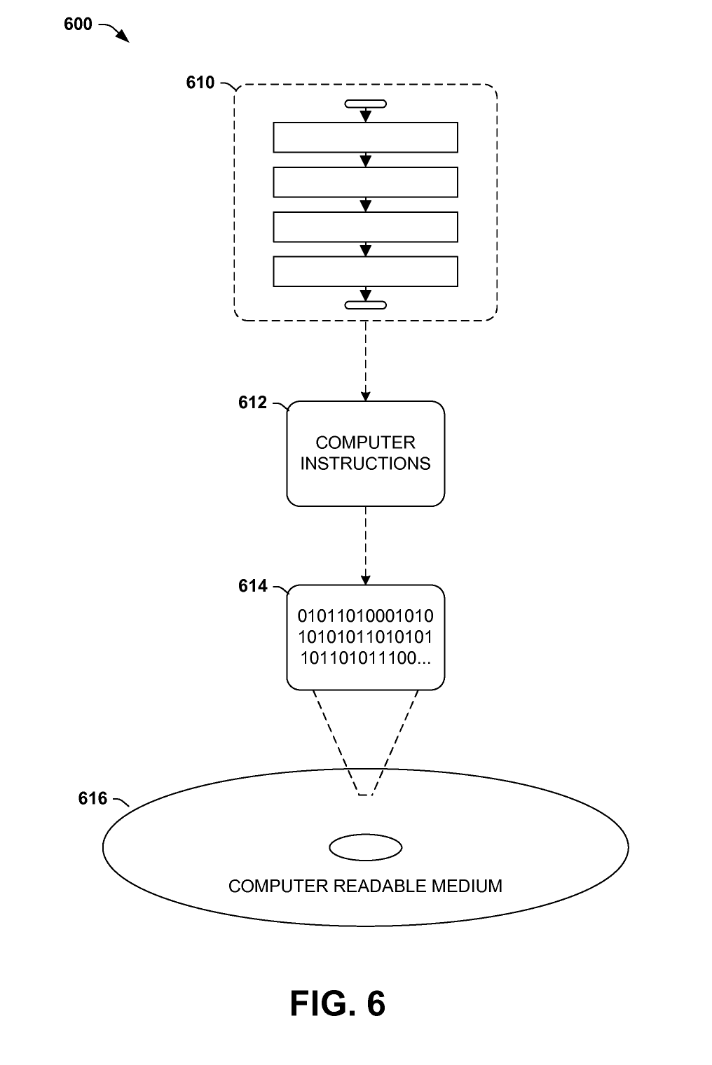

Still another embodiment involves a computer-readable medium comprising processor-executable instructions configured to implement one or more of the techniques presented herein. An exemplary computer-readable medium that may be devised in these ways is illustrated in FIG. 6, wherein the implementation 600 comprises a computer-readable medium 616 (e.g., a CD-R, DVD-R, or a platter of a hard disk drive), on which is encoded computer-readable data 614. This computer-readable data 614 in turn comprises a set of computer instructions 612 configured to operate according to one or more of the principles set forth herein. In one such embodiment 600, the processor-executable computer instructions 612 may be configured to perform a method 610, such as at least some of the exemplary method 100 of FIG. 1 and/or at least some of the exemplary method 200 of FIG. 2, for example. In another such embodiment, the processor-executable instructions 612 may be configured to implement a system, such as at least some of the exemplary system 300 of FIG. 3, least some of the exemplary system 400 of FIG. 4, and/or at least some of the exemplary system 500 of FIG. 5, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

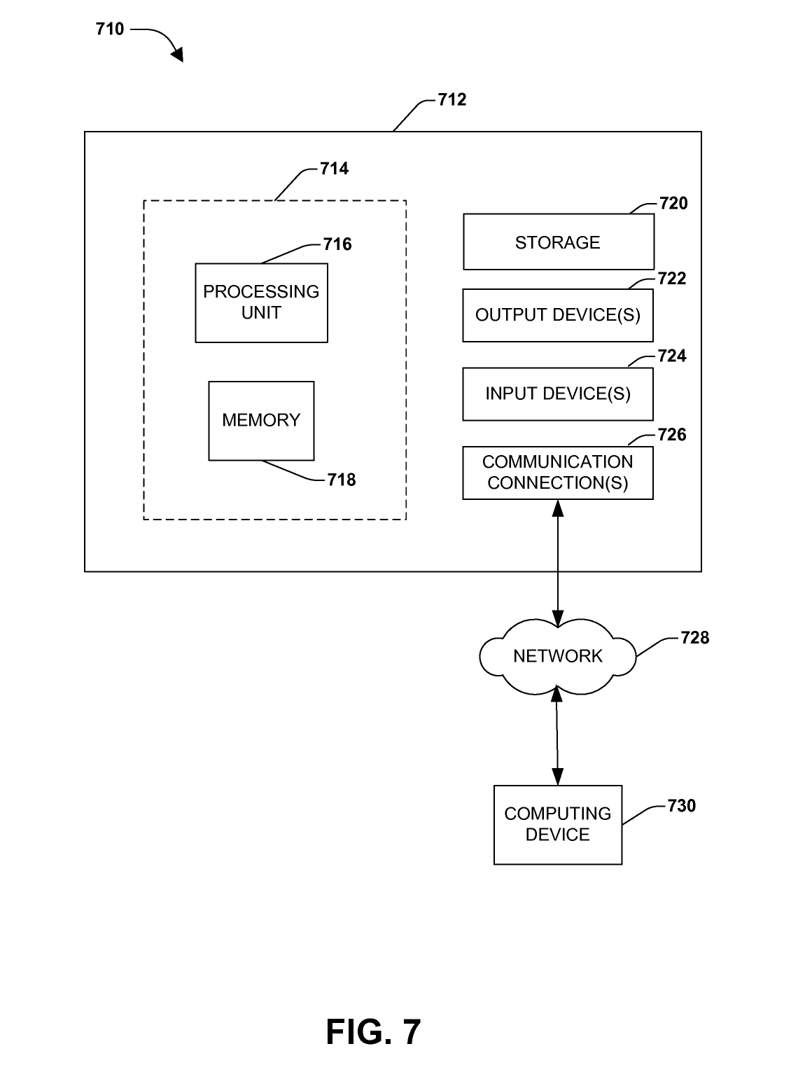

FIG. 7 and the following discussion provide a brief, general description of a suitable computing environment to implement embodiments of one or more of the provisions set forth herein. The operating environment of FIG. 7 is only an example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 710 comprising a computing device 712 configured to implement one or more embodiments provided herein. In one configuration, computing device 712 includes at least one processing unit 716 and memory 718. Depending on the exact configuration and type of computing device, memory 718 may be volatile (such as RAM, for example), non-volatile (such as ROM, flash memory, etc., for example) or some combination of the two. This configuration is illustrated in FIG. 7 by dashed line 714.

In other embodiments, device 712 may include additional features and/or functionality. For example, device 712 may also include additional storage (e.g., removable and/or non-removable) including, but not limited to, magnetic storage, optical storage, and the like. Such additional storage is illustrated in FIG. 7 by storage 720. In one embodiment, computer readable instructions to implement one or more embodiments provided herein may be in storage 720. Storage 720 may also store other computer readable instructions to implement an operating system, an application program, and the like. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Any such computer storage media may be part of device 712.

Device 712 may also include communication connection(s) 726 that allows device 712 to communicate with other devices. Communication connection(s) 726 may include, but is not limited to, a modem, a Network Interface Card (NIC), an integrated network interface, a radio frequency transmitter/receiver, an infrared port, a USB connection, or other interfaces for connecting computing device 712 to other computing devices. Communication connection(s) 726 may include a wired connection or a wireless connection. Communication connection(s) 726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 712 may include input device(s) 724 such as keyboard, mouse, pen, voice input device, touch input device, infrared cameras, video input devices, and/or any other input device. Output device(s) 722 such as one or more displays, speakers, printers, and/or any other output device may also be included in device 712. Input device(s) 724 and output device(s) 722 may be connected to device 712 via a wired connection, wireless connection, or any combination thereof. In one embodiment, an input device or an output device from another computing device may be used as input device(s) 724 or output device(s) 722 for computing device 712.

Components of computing device 712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 712 may be interconnected by a network. For example, memory 718 may be comprised of multiple physical memory units located in different physical locations interconnected by a network.

Those skilled in the art will realize that storage devices utilized to store computer readable instructions may be distributed across a network. For example, a computing device 730 accessible via a network 728 may store computer readable instructions to implement one or more embodiments provided herein. Computing device 712 may access computing device 730 and download a part or all of the computer readable instructions for execution. Alternatively, computing device 712 may download pieces of the computer readable instructions, as needed, or some instructions may be executed at computing device 712 and some at computing device 730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B and/or the like generally means A or B or both A and B.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for generating geometry from one or more depth images, comprising:
generating a grid corresponding to a space within which a rendered image is to be displayed; and
displacing one or more portions of the grid to generate a geometry based upon depth information associated with a first depth image depicting a scene that is to be represented within the rendered image.

2. The method of claim 1, the generating a grid comprising:
tessellating an initial grid to create the grid.

3. The method of claim 1, comprising:
generating a second geometry based upon a second depth image depicting the scene; and
blending the geometry and the second geometry to create a blended geometry.

4. The method of claim 1, the displacing one or more portions of the grid comprising:
displacing vertices of respective geometric shapes within the grid along a depth direction based upon the depth information.

5. The method of claim 1, the geometry comprising at least one of a digital surface model (DSM) or a height map.

6. The method of claim 1, comprising:
receiving the first depth image, at a client, from an image based service; and
generating the geometry, at the client, for rendering by the client.

7. The method of claim 1, the scene depicting at least one of an aerial view of a location or at least a portion of a city.

8. The method of claim 3, the first depth image depicting the scene from a plumb line view direction, and the second depth image depicting the scene from an oblique view direction.

9. The method of claim 1, comprising applying texture information to the geometry to generate the rendered image, the applying comprising:
for respective pixels within the geometry:
projecting a first 3D point associated with a first pixel to a first location within first texture imagery to determine first texture information for the first pixel; and
responsive to a depth of the first pixel corresponding to a depth of the first location, assigning the first texture information to the first pixel, otherwise determining that the first pixel is occluded; and
generating the rendered image based upon texture information assigned to respective pixels within the geometry.

10. The method of claim 9, the projecting a first 3D point comprising:
projecting the first 3D point to a second location within second texture imagery to determine second texture information for the first pixel; and
responsive to the depth of the first pixel corresponding to a depth of the second location:
blending the first texture information and the second texture information together to create blended texture information; and
assigning the blended texture information to the first pixel.

11. The method of claim 1, comprising:
using a pixel shader of a rendering pipeline to render the geometry.

12. The method of claim 9, the first texture imagery comprising a video.

13. The method of claim 9, comprising:
receiving the first texture imagery, at a client, from an image based service; and
generating the rendered image, at the client, for display by the client.

14. A method for texturing geometry using texture imagery, comprising:
receiving a geometry associated with a scene that is to be represented within a rendered image;
for respective pixels within the geometry:
projecting a first 3D point associated with a first pixel to a first location within first texture imagery to determine first texture information for the first pixel; and
responsive to a depth of the first pixel corresponding to a depth of the first location, assigning the first texture information to the first pixel, otherwise determining that the first pixel is occluded; and
applying texture information assigned to respective pixels within the geometry to generate the rendered image.

15. The method of claim 14, the receiving geometry comprising:
receiving a first depth image depicting the scene that is to be represented within the rendered image;
generating a grid corresponding to a space within which the rendered image is to be displayed; and
displacing one or more portions of the grid to generate the geometry based upon depth information associated with the first depth image.

16. The method of claim 14, comprising:
receiving the first texture imagery, at a client, from an image based service; and
generating the rendered image, at the client, for display by the client.

17. The method of claim 14, the projecting a first 3D point comprising:
projecting the first 3D point to a second location within second texture imagery to determine second texture information for the first pixel; and
responsive to the depth of the first pixel corresponding to a depth of the second location:
blending the first texture information and the second texture information together to create blended texture information; and
assigning the blended texture information to the first pixel.

18. The method of claim 14, the first texture imagery comprising a video.

19. The method of claim 14, comprising:
utilizing a where graph to identify the geometry and the first texture imagery for use in generating the rendered image, the where graph comprising relationship information between at least one of geometry or texture imagery.

20. A system for rendering an image, comprising:
a geometry generation component, hosted by a client, configured to:
receive a first depth image from an image based service, the first depth image depicting a scene that is to be represented within a rendered image;
generate a grid corresponding to a space within which the rendered image is to be displayed; and
displace one or more portions of the grid to generate a geometry based upon depth information associated with the first depth image; and
a texturing component, hosted by the client, configured to:
receive first texture imagery from the image based service;
for respective pixels within the geometry:
project a first 3D point associated with a first pixel to a first location within the first texture imagery to determine first texture information for the first pixel; and
responsive to a depth of the first pixel corresponding to a depth of the first location, assign the first texture information to the first pixel, otherwise determine that the first pixel is occluded; and
generate the rendered image based upon texture information assigned to respective pixels within the geometry.
